(19) United States
(12) Patent Application Publication
(10) Pub. No.: US 2003/0198280 A1
(43) Pub. Date: Oct. 23, 2003

(54) Wireless local area network frequency hopping adaptation algorithm

(76) Inventors: John Z. Wang, Algonquin, IL (US); Dawn W. Close, West Palm Beach, FL (US)

Correspondence Address: Donald J. Ersler, 725 Gravens Avenue, Brookfield, WI, 53005, US

(21) Appl. No.: 10/127,118

(22) Filed: Apr. 22, 2002

(51) Int. Cl. H04B 1/713

(52) U.S. Cl. 375/132

(57) ABSTRACT

The frequency hopping adaptation algorithm is an interference avoidance algorithm allowed by the U.S. FCC for ISM band spread spectrum systems. The frequency hopping adaptation algorithm is designed for ISM band frequency hopping systems such as IEEE 802.11 FH, HomeRF 2.0 (including wide band frequency hopping), Bluetooth and other frequency hopping systems.

### BACKGROUND OF THE INVENTION

1. Field of the Invention

The present invention relates generally to frequency hopping and more specifically to a wireless local area network frequency hopping adaptation algorithm which provides much higher capacity and satisfactory channel quality than that of the prior art.

2. Discussion of the Prior Art

The future communication system is commonly referenced as the Third Generation communication systems or simply 3G. It is designed to offer wide band multi-media applications in addition to the cellular services. Due to the high cost of the 3G licenses some of the 3G-license owners returned their licenses. The success of Wireless Local Area Network (WLAN) is one of the basic reasons for their action. The fundamental reason that WLAN presents such a threat to the 3G systems is its free wide bandwidth. All the WLAN systems work in ISM bands. The bandwidth of the 2.4 GHz unlicensed band is 83.5 MHz. There is a growing concern, even in Europe that the UMTS (European version of 3G solution) would fail, because of the success of WLAN. Many companies are aligning their strategies with the success of WLAN.

Since the U.S. government's implementation of the bandwidth auction procedure, the attention had been shifted to the free ISM bands. Such systems as Bluetooth, IEEE 802.11, IEEE 802.11a/b/g, HomeRF, etc. work in the bands shared with other existing users. Since no one system is granted exclusive use of the bandwidth, a fundamental limitation for these systems is unpredictable interference. To be fair to all potential users of the ISM bands, the U.S. FCC requires that only Code Divided Multiple Access (CDMA) systems such as Frequency Hopping Spread Spectrum (FHSS), Direct Sequence Spread Spectrum (DSSS), and recently released Orthogonal Frequency Division Multiplexing (OFDM) technologies be used in these bands. No cooperation is allowed among any of the transceivers. For the FHSS system, the hopping sequence must be selected individually and independently.

It is well known that existing FHSS has a much better performance than that of the DSSS in the interference limited environments. For example, operation of a Bluetooth (FHSS) system will create a more severe interference to the operation of a IEEE 802.11b (DSSS) system then will the IEEE 802.11b system for the Bluetooth (FHSS) system. The fundamental reason is that the Bluetooth system enjoys a much higher process gain (79) than that of the IEEE 802.11b system (2-11). The higher the processing gains, the better the immunity from interferences. However, better performance of the FHSS system in the interference-limited environment than the DSSS system does not qualify the FHSS as an efficient solution for commercial applications in the public environments. To be able to work efficiently in a public environment, the FHSS system has to fight with other FHSS systems (intra-system interference) operating at the same time.

Simulation results and theoretic analysis indicate that for co-located FHSS systems, for example: Bluetooth and IEEE802.11; the Hop Hitting Rate (HHR) generated by intra-system interference for a duplex channel, such as a telephone connection, is a function of the number of independent concurrent users as shown in Table 1:

TABLE 1
HHR for Duplex Channels

| | | | | | | |
|---|---|---|---|---|---|---|
| Number of | 2 | 3 | 4 | 5 | 6 | 7 |
| users | | | | | | |
| HHR | 2.53% | 7.53% | 14.84% | 24.22% | 35.34% | 47.85% |

As shown in Table 1 the channel quality is severely damaged when there are only a few concurrent users. Since the aforementioned systems lack effective co-existence, most of the existing WLAN systems are installed in private environments such as homes and businesses. To be an integral part of future public communication systems, a solution is needed for WLAN frequency hopping that is able to offer high system capacity with satisfactory quality for various applications in many different environments. Recently, the U.S. FCC allowed an Adaptive Frequency Hopping technology to be implemented in the ISM band FH systems with a restriction that the adaptation must be made individually and independently.

Accordingly, there is a clearly felt need in the art for a wireless local area network frequency hopping adaptation algorithm that allows the co-operation of many like systems in the ISM band with much higher capacity and satisfactory channel quality than that of the prior art.

### SUMMARY OF THE INVENTION

The present invention provides a wireless local area network frequency hopping adaptation algorithm (frequency hopping adaptation algorithm) which minimizes intra-system inference between like system operation. The frequency hopping adaptation algorithm is an interference avoidance algorithm allowed by the U.S. FCC for ISM band spread spectrum systems. The frequency hopping adaptation algorithm is designed for frequency hopping systems such as IEEE 802.11 FH, HomeRF 2.0 (including wide band frequency hopping), Bluetooth and other frequency hopping systems. The frequency hopping adaptation algorithm implements a frequency hopping interference avoidance technology. The frequency hopping adaptation algorithm gradually adapts to an interference-limited environment. The adaptive decision is made individually and independently to comply with the U.S. FCC rules.

The frequency hopping adaptation algorithm is able to carry up to between 60 to 64 high quality channels for users of the Bluetooth system. When utilizing the frequency hopping adaptation algorithm co-located Bluetooth transceivers (a worst case scenario) are capable of operating without significant intra-system interferences. The system capacities for other frequency hopping systems are even higher. The frequency hopping adaptation algorithm is convergent with a fair converging rate. The hopping hitting rate approaches zero when the system reaches its stationary stage even for a highly loaded system.

Accordingly, it is an object of the present invention to provide a frequency hopping adaptation algorithm that allows the frequency hopping systems in the ISM band achieve much higher capacity and satisfactory channel quality than that of the prior art.

These and additional objects, advantages, features and benefits of the present invention will become apparent from the following specification.

### BRIEF DESCRIPTION OF THE DRAWINGS

FIG. 1 is an overall flow chart of the frequency hopping adaptation algorithm in accordance with the present invention.

FIG. 2 is a flow chart of a channel quality monitoring process of a frequency hopping adaptation algorithm in accordance with the present invention.

FIG. 3 is a flow chart of a channel adaptation process of a frequency hopping adaptation algorithm in accordance with the present invention.

### DETAILED DESCRIPTION OF THE PREFERRED EMBODIMENTS

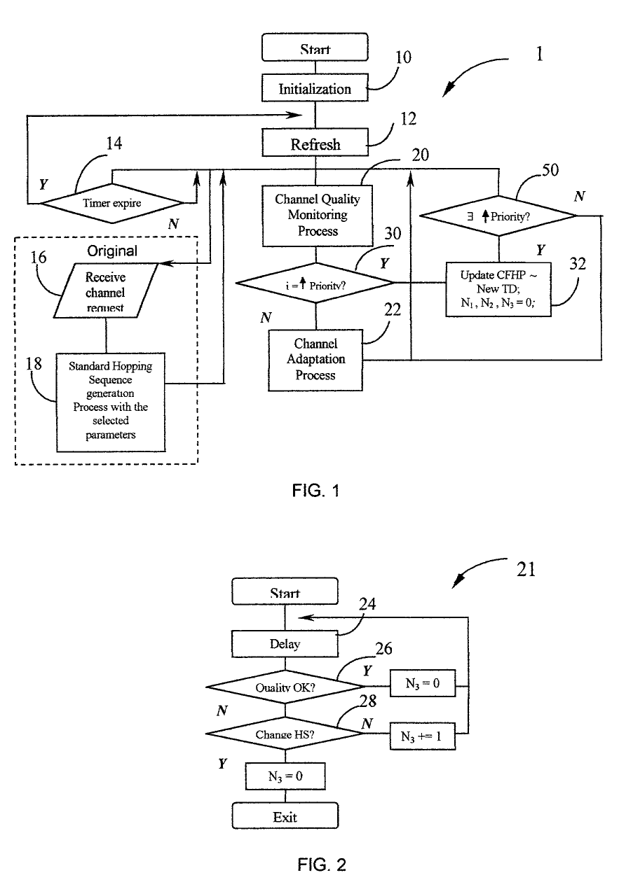

With reference now to the drawings, and particularly to FIG. 1, there is shown a flow chart of a frequency hopping adaptation algorithm 1. The frequency hopping adaptation algorithm includes the processes of initialization, refresh control, hopping sequence generation, hopping sequence adaptation, and priority management. The hopping sequence generation process is enclosed in a dashed box marked as “Original” in FIG. 1. The hopping sequence generation is identical to that specified in Bluetooth, ANSI/IEEE Std 802.11, and HomeRF 2.0 specifications.

The frequency hopping adaptation algorithm works with two types of frequency hopping (FH) systems. Type I FH system is characterized by the long cycle period of its hopping sequence. For example, Bluetooth has a hopping sequence cycle longer than 200,000,000. To ensure long cycle time, the system usually adopts hopping sequence generating parameters with long cycle time themselves. Bluetooth is a Type I system. A Type II FH system is characterized by the short cycle period of its hopping sequence. For example, IEEE 802.11 FH has a cycle time of 79, HomeRF 2.0 1 MHz solution has a cycle time of 75 with 75 distinguished frequency hops and HomeRF WBFH has a cycle time of 75 with 15 distinguished frequency hops. IEEE 802.11 FH and HomeRF are Type II systems.

In frequency hopping systems it is the hopping sequence and phase that identify the logical channel. The hopping sequence and phase are determined by frequency hopping parameters. The interference avoidance is implemented through modifying the frequency hopping parameters. There are two types of frequency hopping parameters. The input frequency hopping parameters of the frequency hopping adaptation algorithm 1 are referred to as the candidate frequency hopping parameters (CFHP). The output frequency hopping parameters of the of the frequency hopping adaptation algorithm 1 are referred to as active frequency hopping parameters (AFHP). Both the AFHP and the CFHP are variables. Initially, the AFHP and the CFHP are identical to the native FHP and keep changing in the course of hopping sequence adaptation process. It is the AFHP that are used for the hopping sequence generation process. The AFHP and the CFHP also share the same format.

In Type I system, the hopping sequence and phase are determined by the address and clock of the master station.

PR₁=Address¹;

PR₂=CLK²;

Where superscript nos. 1 and 2 are specified in Bluetooth specification Version 1.1

In Type II systems, the hopping sequence is determined by the channel pattern number and phase.

PR₁=Phase i³;

PR₂=Hopping Pattern Number⁴;

The FHP such as device Address and Clock for Type I system and channel pattern number and Phase for Type II systems is defined in the related standards. Where superscript no. 3 is the phase number specified in ANSI/IEEE Std 802.11, 1999 edition, HomeRF version 2.0 specification. Where superscript no. 4 is the hopping pattern number specified in ANSI/IEEE Std 802.11, 1999 edition, HomeRF specification Version 2.0 It should be pointed out that the two-dimensional channel group/hopping pattern is a special case of the proposed solution. It can be implemented easily through an one-dimensional hopping pattern.

The frequency hopping adaptation algorithm 1 includes a first process of initialization in process block 10. The initialization procedure is triggered when system is powered on. The following example of an initialization process is given by way of example and not by way of limitation.

Bluetooth System

For P=79 hop systems, the thresholds Th₁ and Th₂, are adjustable. They are functions of the desired maximum system capacity.

Define Class 1 Bluetooth system to be the system where the desired maximum system capacity is up to Thirty-Two concurrent users. The suggested thresholds are as follows:

Th₁=32;

Th₂=1;

Define Class 2 Bluetooth system to be the system where the desired maximum system capacity is up to Sixty-four concurrent users. The suggested thresholds are as follows:

Th₁=64;

Th₂=1;

Not losing generality, the value of Th₁ could be any number up to the maximum desired channel capacity for a Bluetooth system.

Define Category I Bluetooth system to be a system where only the lower part of PR₁ (e.g. below bit 14) are adjustable, and Category II Bluetooth system to be a system where at least one of the adjustable bits is higher than or equal to bit 14 (up to Bit 27) of PR₁.

In P=23 Hop Systems⁵, for the maximum system capacity to be 16, the suggested thresholds are as follows:

Th₁=16;

Th₂=1;

The Th₁, Th₂ could be of any other values; e.g. for Class 2 system, assign Th₁=32, Th₂=2. The values shown above are the preferred values.

Where superscript no. 5 is the solution for Bluetooth P=23 is similar to that for P=79. The invention is directed at solutions for P=79.

Define Address Pattern Matrix, AP, as a 2-by-2-by-m-by-p matrixes. The values of the first two indexes are the the number of Classes and the number of Categories in the system. The values of m and p are functions of the selected Class and Category. For example, for Category II, Class 1 system m=64, p=5. For Category II, Class 2 system the numbers are m=16 and p=6.

Define AP_{cijk} as the k^{th} bit position of an address for an Address Pattern j of Category i, Class c. For example, AP_{2,2,1,6}=27 means the sixth bit position for the 1^{st} Address Pattern of Category 2, Class 2 system is bit 27 of the related address.

In case where the dynamic range of PR₁ is restricted, for example, only the lower part of it is adjustable, the Category I vectors are suggested as the solution.

There are m one-by-p candidate vectors that are qualified to be part of the AP_{ci} Matrix for Category i, Class c. Any one of them is able to offer up to 2^{p} concurrent channels without intra-system interference. Not losing generality, as a preferred embodiment, up to r (r=min(m, 32)) candidate vectors are selected for that Matrix. Please reference Appendix A for further details.

Define the Pattern Selection Bit (PSB) vector: a one-by-t vector (t=log₂r, t=5 when r=32)

PSB is used to identify the index of the vectors in the AP matrixes. The PSB is redundant when the AP Matrix has only one vector.

The PSB is used in the Address Update processes.

PSBᵢ denotes i^{th} bit position number of an address for Pattern Selection. For example, PSB₄=8 means the forth bit position for Pattern Selection is the 8^{th} address bit.

The PSB for Bluetooth is defined as (2,4,6,8,10). By this definition, up to 32 vectors are identifiable for the AP matrixes. When there are less then 32 vectors, for example: h vectors, only the lower s bits identified by the PSB vector are used for vector identification,

where: 2^{s-1}<h<=2^{s}.

As an example the AP vector with the index number 5 is selected if A₂, A₄, A₆, A₈, A₁₀=1, 0, 1, 0, 0, where Aᵢ is the i^{th} address bit of the referenced Address.

Type II Systems

For Type II systems where the Hopping Pattern number of neighbor networks are available:

Th₁=# of Phases per Hopping sequence in the system (e.g. 79);

Th₂=1;

P=# of Phases per Hopping sequence in the system (e.g. 79);

PR₁=Phase of the active independent Hopping sequence of the TD (Transceiver Device e.g. Access Point) with the highest priority;

PR₂=the active independent Hopping sequence specified by the CFHP.

Other Type II Systems

For other Type II FH systems, such as IEEE 802.11 FH, HomeRF 2.0 systems, with N independent hopping sequences of fixed lengths, that function not depending on any information of other devices [referenced as Other Type II FH systems in this document]:

Th₁=# of Phases per Hopping sequence in the system;

Th₂=# of independent Hopping sequence in the system;

P=# of Phases per Hopping sequence;

PR₁=Phase of the active independent Hopping sequence;

PR₂=active independent Hopping sequence;

It should be pointed out that the two channel spacing (1 MHz/5 MHz) of HomeRF v2.0 share the same parameter: Th₁=75, Th₂=75.

After the initialization process is completed in process block 10, the refresh process starts in process block 12. The refresh process will be triggered either when the system is powered on or when the refresh timer expires. The refresh timer is monitored within process block 14. The Refresh Timer is set when all potential solutions have been tried without finding a single usable channel. Whenever the Refresh Timer expires the refresh process is invoked.

The refresh process sets:

Channel Quality=True;

Refresh Timer=Off;

Set Validation Timer;

N₁=0;

N₂=0;

N₃=0;

Max=0;

Min=P;

Count=0;

The channel allocation process will begin as soon as a valid channel request is received from input-output block 16. When a valid channel request is received, the channel allocation process will invoke the standard hopping sequence generation process found in process block 18. The hopping sequence generation processes are defined in the following standards. For IEEE 802.11 FH, the hopping sequence generation process is specified in ANSI/IEEE STD 802.11 1999 Edition. For Bluetooth systems, the hopping sequence generation process is specified in the Bluetooth Specification Version 1.1. For HomeRF systems, the hopping Sequence generation process is specified in HomeRF Specification Version 2.0. The inputs of the generators are the active frequency hopping parameters (AFHP). The AFHP is broadcast as the identity of the transceiver device.

Channel quality monitoring process occurs in process block 20. FIG. 2 shows a channel quality flow chart 21 which provides the details of the process block 20. The channel quality monitoring process is a measurement of the quality of the current logical channel. The current logical channel is identified by active frequency hopping parameters. The channel quality could be an instant measurement such as receive signal strength indicator (RSSI) or eye-opening implemented in Carrier Sense/Measure Before Use procedures. Channel quality can also be measured by the statistics of the channel quality. For example, the hop hitting rate (HHR) or the packet error rate may be monitored. Alternatively, channel quality may be an input from the end user. The channel quality monitoring process preferably uses quality statistics such as hopping hitting due to quality and stability considerations.

The hopping hitting rate of the active hopping sequence is evaluated through a moving window of size L₁ (for example, an exponential moving average with window L₁=79 measured at regular or irregular intervals). Preferably, the channel quality is defined to be OK, if (HHR<Th₅) [for example Th₅=5]; otherwise channel quality is Not OK. Maximal and Minimal HHR values for the active hopping sequence are also recorded.

If HHR>Max, Max=HHR; else

If HHR<Min, Min=HHR;

To ensure convergence of the frequency hopping adaptation algorithm 1, the channel quality monitoring process will make multiple channel quality measurements before a decision is made on whether the channel adaptation process should be invoked. The channel adaptation process is contain within process block 22. Channel quality measurements do not have to be measured continuously. Preferably, the measurements are performed in multiple distinct instances. The instances could be at some multiple of the number of hops, at the end of a burst of data transmission, or at any other appropriate event. Since channel quality measurements are not continuously made, there is a delay in the channel quality flow chart 21. The delay of channel quality measurements occurs in process block 24.

A parameter PR₅ is defined as a transceiver device specific parameter (for example, address or hopping pattern number). The preferred selection for Type I system is the transceiver device's native address. A parameter PR₆ is defined as a function of the event of HHR>Th₄ and/or HHR<Th₅ for the active hopping sequence over a window of a variable size L₂. The window should include all the measurement instances since the last time when the active frequency hopping parameters was updated. One potential implementation of PR₆ is as follows:

PR₆=Count (HHR>Th₄ || HHR<Th₅); where the function Count (EV) is the number of occurrence of the event EV in a window L₂[e.g. Th₅=5, Th₄=70 for Bluetooth, IEEE 802.11 FH and HomeRF Version 2.0 systems].

Define CI=0 if HHR>Th₄ and CI=1 otherwise.

Define Th₃=f (PR₅, PR₆, CI), where the function f is an increasing function of PR₅ and PR₆. For example, the preferred implementation of the function f is defined as follows:

Th₃=(C₅*(1+PR₅ MOD (C₆))+C₇*CI*PR₆)/C₈;

Where C₅, C₆, C₇, C₈ are adjustable constants. The preferred values are C₅=2, C₆=8 and C₇=40.

When a measurement of quality is triggered, the quality is determined in process block 26. If the channel quality is satisfactory, the control will set N₃ to zero and exit the channel quality monitoring process. If the channel quality is not satisfactory, changing the hopping sequence (HS) is considered in process block 28. To determine whether the hopping sequence should be changed, define the Change hopping sequence to be True if N₃>Th₃; otherwise it is False.

If hopping sequence set to True, Set:

N₃=0;

Max=0;

Min=P;

Count=0;

The hopping sequence will not be changed when Change hopping sequence set to False.

If the Change hopping sequence set to False, Set:

N₃+=1;

If (Max>Th₄)

Count+=1;

If (Min<Th₅)

Count+=1;

Max=0;

Min=P;

The program then loops back to process block 24.

Priority is determined in decision block 30 for systems where comparisons of active frequency hopping parameters for relevant transceiver devices are performed. For systems that are irrelevant to priority, the result for any priority related testing will always be false in decision blocks 30 and 50. Priority is an arbitrary ordering among all transceiver devices involved in the system. The only requirement for priority is the uniqueness on the ordering of any pair of related transceiver devices. For example, in a Bluetooth system, a transceiver device has a higher priority over another one if the transceiver device has an active address (as a component of its active frequency hopping parameters) with higher (or lower) numerical value than that of the other. Bluetooth and some Type II systems require the implementation of priority.

In decision block 30 a test is made on whether the current transceiver device is identical to the transceiver device recorded locally as the transceiver device with the highest priority. If the result of the testing is true, no action is taken, the process stops. If the result of the testing is false, the channel adaptation process in block 22 is then entered.

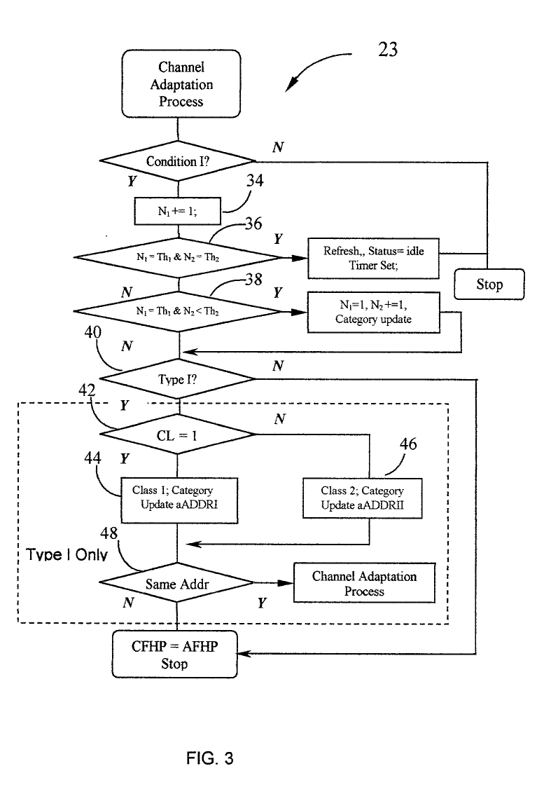

The channel adaptation process occurs in process block 22. FIG. 3 shows a channel adaptation flow chart 23 which provides the details of the process block 22. The channel adaptation process is accessible from outside process block 22 when Condition I is set to True. Condition I is True, if all of the following conditions are met: (1) the quality of the current channel is not OK; (2) the referenced system is in standby state; and (3) after a successful inquiry with up-to-date frequency hopping parameter information (for a priority relevant system). The input of the channel adaptation process is a candidate frequency hopping parameter (CFHP) and the output is an updated CFHP and an active frequency hopping parameter (AFHP).

In the channel adaptation process, define N₁<=Th₁ to be the index of PR₁ and N₂<=Th₂ to be the index of PR₂. In process block 34, N₁ is incremented by one. In decision block 36, a test performed to determine if N₁ is identical to Th₁ and N₂ is identical to Th₂. If the answer is Yes, a refresh timer is set; current status is changed to idle; and the control exits the channel adaptation process. If the answer is No, the control continues to decision block 38. In decision block 38, a test is performed to determine if N₁ is identical to Th₁ and N₂ is less than Th₂. If the answer is Yes, N₁ is assigned a value of “1” and N₂ is incremented by one and the control continues to decision block 40. If the answer is No, the control continues to decision block 40.

In decision block 40, a test is performed to determine if the system is Type I. If the answer is No, the control exits the channel adaptation process with updated AFHP indexes. Where the N₁ is the index of the phase and N₂ is the index of hopping pattern/hopping sequence. The CFHP is also updated to be identical to that of the AFHP. Not losing generality, the mapping between N₁/N₂ and hopping pattern/hopping sequence could be any function. Preferably, index mapping is used.

For Type I systems such as Bluetooth, the class is tested in decision block 42. If the system is a Class 1 (CL 1) system, the control continues to process block 44, where a procedure Update aADDRI is called to update the active address for a preselected category. If the system is not a class 1 system, the control continues to process block 46, where a procedure Update aADDRII is called to update the active address for a preselected category.

Whether the system is class 1 or class 2, the control goes to decision block 48. A test is performed in decision block 48 to determine if the address of PR₁ is identical to that of a known transceiver device. If the answer is No, the channel adaptation process stops; otherwise the control proceeds to a recursive call of the channel adaptation process. However, the testing done in decision block 48 is optional. Implementing decision block 48 speeds up the convergent rate. An active clock of a transceiver device in a Type I system is set to be identical to that of the CFHP as a component of the updated AFHP. Before exiting the channel adaptation process, the CFHP is updated to be identical to that of the updated AFHP.

In the Update aADDRI process, the active address of the current transceiver device (component of AFHP) is derived from that of the transceiver device with the highest priority component of CFHP (as a component of AFHP). The active address bits of the current transceiver device are identical to that of the transceiver device with the highest priority except p bits (p=5) that are identified by bit number B₁ . . . Bₚ of the related address. Where: Bₖ=AP_{cijk} k=1 . . . p;

Where the matrix AP_{ci} is identified by the Class c (=1) and Category i (for details please reference Appendix A). The index j is identified by the five bits, in its binary format, of the Active Address of the known TD with the highest priority with bit locations specified by the vector PSB. The values of the p bits, B₁ . . . Bₚ of the derived active address of the current transceiver device are the binary representations of an integer L. The value of L is either equal to N₁ or a random number:

L=(RAN (0, Th₁−1)), where RAN is a random number generator.

The preferred embodiment is L=N₁.

The Update aADDRII process is identical to the Update aADDRI process, except that c=2; p=6 and minor differences in the implementations of the two Categories. There is only one vector in the AP₂₁ matrix and the values of L from 32 to 35 are not used. This limits the maximum number of concurrent channel usage of the system to be sixty for Category 1 systems. There are sixteen vectors in the AP₂₂ matrix without any limitation on the L values in the solution for Category 2 systems. This leads to system capacity to be sixty-four for the Class 2 Category 2 type 1 system.

After power-on, a priority dependent system will monitor the surrounding environment for potential transceiver devices with higher priority in decision block 50. The priority monitoring process may be implemented through channel measurements (ie: receive signal strength indicator (RSSI)) or other suitable methods supported by the existing protocol. The priority monitoring process may be performed on a regular or non-regular basis.

When the implementation is based on channel measurements, the related transceiver device is required to monitor the received signal of the hops within a window on a channel identified by a Testing frequency hopping parameter (TFHP). Statistics of the measurements such as testing hop occupancy rate (THOR), the measure of percentage of hops with RSSI>Th₇, should also be supported. A TFHP becomes the AFHP of another transceiver device when the related THOR>Th₄ is recorded. The TFHP is derived from the transceiver device's local information. A sequential or random selection is used if no local information is usable.

Each transceiver device keeps records on the AFHP of the known transceiver device with the highest priority as its own CFHP. The initial value of the CFHP is its own native frequency hopping parameters (NFHP). Whenever a new transceiver device with a higher priority is detected, the updating process in process block 32 is accessed. The AFHP of the transceiver device with the highest priority will be recorded as its own CFHP. In addition, the following variables are reset:

Count=0;

N₁=0;

N₂=0;

N₃=0;

Refresh Timer=Off;

Validation Timer reset

After the variables are reset, the priority process then stops. If no new transceiver device with a higher priority is detected, the process stops.

There is a validation timer associated with each of the recorded AFHP of all the known neighboring transceiver devices. Whenever valid AFHP information is updated for a transceiver device, the validation timer is refreshed. When the validation timer of a transceiver device expires, the record of that transceiver device will be discarded. In the case where a transceiver device with an expired validation timer was the known by the transceiver device with the highest priority, the local transceiver device will reset the CFHP with its own NFHP and start the process to identify the transceiver device with the highest priority.

Appendix A;

AP₁₁ for Class 1 Category 1 Type 1

All the address pattern (AP) vectors for the Class 1 Category 1 address pattern matrix (APM) are listed as follows: Any one of them is able to fulfill the task of offering thirty-two concurrent channels without intra-system interference.

| i | B1 | B2 | B3 | B4 | B5 |
|---|---|---|---|---|---|
| 1 | 1 | 3 | 5 | 7 | 9 |
| 2 | 1 | 3 | 5 | 7 | 11 |
| 3 | 1 | 3 | 5 | 9 | 11 |
| 4 | 1 | 3 | 7 | 9 | 11 |
| 5 | 1 | 5 | 7 | 9 | 11 |
| 6 | 3 | 5 | 7 | 9 | 11 |
| 7 | 3 | 5 | 7 | 9 | 13 |
| 8 | 3 | 5 | 7 | 11 | 13 |

The vectors are indexed by the pattern selection bit (PSB) vector.

AP₁₂ for Class 1 Category 2 Type 1

All the AP vectors for the Class 1 Category 2 APM are listed as follows: Any one of them is able to fulfill the task of offering thirty-two concurrent channels without intra-system interference.

| i | B1 | B2 | B3 | B4 | B5 |
|---|---|---|---|---|---|
| 1 | 11 | 19 | 20 | 21 | 22 |
| 2 | 11 | 19 | 20 | 21 | 26 |
| 3 | 11 | 19 | 20 | 21 | 27 |
| 4 | 11 | 19 | 20 | 22 | 25 |
| 5 | 11 | 19 | 20 | 22 | 27 |
| 6 | 11 | 19 | 20 | 25 | 26 |
| 7 | 11 | 19 | 20 | 25 | 27 |
| 8 | 11 | 19 | 20 | 26 | 27 |
| 9 | 11 | 19 | 21 | 22 | 24 |
| 10 | 11 | 19 | 21 | 22 | 27 |
| 11 | 11 | 19 | 21 | 24 | 26 |
| 12 | 11 | 19 | 21 | 24 | 27 |
| 13 | 11 | 19 | 21 | 26 | 27 |
| 14 | 11 | 19 | 22 | 24 | 25 |
| 15 | 11 | 19 | 22 | 24 | 27 |
| 16 | 11 | 19 | 22 | 25 | 27 |
| 17 | 11 | 19 | 24 | 25 | 26 |
| 18 | 11 | 19 | 24 | 25 | 27 |
| 19 | 11 | 19 | 24 | 26 | 27 |
| 20 | 11 | 19 | 25 | 26 | 27 |
| 21 | 11 | 20 | 21 | 22 | 23 |
| 22 | 11 | 20 | 21 | 22 | 27 |
| 23 | 11 | 20 | 21 | 23 | 26 |
| 24 | 11 | 20 | 21 | 23 | 27 |
| 25 | 11 | 20 | 21 | 26 | 27 |
| 26 | 11 | 20 | 22 | 23 | 25 |
| 27 | 11 | 20 | 22 | 23 | 27 |
| 28 | 11 | 20 | 22 | 25 | 27 |
| 29 | 11 | 20 | 23 | 25 | 26 |
| 30 | 11 | 20 | 23 | 25 | 27 |
| 31 | 11 | 20 | 23 | 26 | 27 |
| 32 | 11 | 20 | 25 | 26 | 27 |
| 33 | 11 | 21 | 22 | 23 | 24 |
| 34 | 11 | 21 | 22 | 23 | 27 |
| 35 | 11 | 21 | 22 | 24 | 27 |
| 36 | 11 | 21 | 23 | 24 | 26 |
| 37 | 11 | 21 | 23 | 24 | 27 |
| 38 | 11 | 21 | 23 | 26 | 27 |
| 39 | 11 | 21 | 24 | 26 | 27 |
| 40 | 11 | 22 | 23 | 24 | 25 |
| 41 | 11 | 22 | 23 | 24 | 27 |
| 42 | 11 | 22 | 23 | 25 | 27 |
| 43 | 11 | 22 | 24 | 25 | 27 |
| 44 | 11 | 23 | 24 | 25 | 26 |
| 45 | 11 | 23 | 24 | 25 | 27 |
| 46 | 11 | 23 | 24 | 26 | 27 |
| 47 | 11 | 23 | 25 | 26 | 27 |
| 48 | 11 | 24 | 25 | 26 | 27 |
| 49 | 19 | 20 | 21 | 22 | 27 |
| 50 | 19 | 20 | 21 | 26 | 27 |
| 51 | 19 | 20 | 22 | 25 | 27 |
| 52 | 19 | 20 | 25 | 26 | 27 |
| 53 | 19 | 21 | 22 | 24 | 27 |
| 54 | 19 | 21 | 24 | 26 | 27 |
| 55 | 19 | 22 | 24 | 25 | 27 |
| 56 | 19 | 24 | 25 | 26 | 27 |
| 57 | 20 | 21 | 22 | 23 | 27 |
| 58 | 20 | 21 | 23 | 26 | 27 |
| 59 | 20 | 22 | 23 | 25 | 27 |
| 60 | 20 | 23 | 25 | 26 | 27 |
| 61 | 21 | 22 | 23 | 24 | 27 |
| 62 | 21 | 23 | 24 | 26 | 27 |
| 63 | 22 | 23 | 24 | 25 | 27 |
| 64 | 23 | 24 | 25 | 26 | 27 |

Not losing generality, thirty-two out of the sixty-four are selected to form the APM for Class 1 Category 2 solution as listed below.

| i | B1 | B2 | B3 | B4 | B5 |
|---|---|---|---|---|---|
| 1 | 11 | 19 | 20 | 21 | 22 |
| 2 | 11 | 19 | 20 | 21 | 26 |
| 3 | 11 | 19 | 20 | 21 | 27 |
| 4 | 11 | 19 | 20 | 22 | 25 |
| 5 | 11 | 19 | 20 | 22 | 27 |
| 6 | 11 | 19 | 20 | 25 | 26 |
| 7 | 11 | 19 | 20 | 25 | 27 |
| 8 | 11 | 19 | 20 | 26 | 27 |
| 9 | 11 | 19 | 21 | 22 | 24 |
| 10 | 11 | 19 | 21 | 22 | 27 |
| 11 | 11 | 19 | 21 | 24 | 26 |
| 12 | 11 | 19 | 21 | 24 | 27 |
| 13 | 11 | 19 | 21 | 26 | 27 |
| 14 | 11 | 19 | 22 | 24 | 25 |
| 15 | 11 | 19 | 22 | 24 | 27 |
| 16 | 11 | 19 | 22 | 25 | 27 |
| 17 | 11 | 19 | 24 | 25 | 26 |
| 18 | 11 | 19 | 24 | 25 | 27 |
| 19 | 11 | 19 | 24 | 26 | 27 |
| 20 | 11 | 19 | 25 | 26 | 27 |
| 21 | 11 | 20 | 21 | 22 | 23 |
| 22 | 11 | 20 | 21 | 22 | 27 |
| 23 | 11 | 20 | 21 | 23 | 26 |
| 24 | 11 | 20 | 21 | 23 | 27 |
| 25 | 11 | 20 | 21 | 26 | 27 |
| 26 | 11 | 20 | 22 | 23 | 25 |
| 27 | 11 | 20 | 22 | 23 | 27 |
| 28 | 11 | 20 | 22 | 25 | 27 |
| 29 | 11 | 20 | 23 | 25 | 26 |
| 30 | 11 | 20 | 23 | 25 | 27 |
| 31 | 11 | 20 | 23 | 26 | 27 |
| 32 | 11 | 20 | 25 | 26 | 27 |

The vectors are indexed by the PSB vector.

AP₂₁ for Class 2 Category 1 Type 1

There is one AP vector for the Class 2 Category 1 APM. It is able to fulfill the task of offering up to sixty concurrent channels without intra-system interference.

| i | B1 | B2 | B3 | B4 | B5 | B6 |
|---|---|---|---|---|---|---|
| 1 | 1 | 3 | 5 | 7 | 9 | 11 |

AP₂₂ for Class 2 Category 2 Type 1

All the AP vectors for the Class 2 Category 2 APM are list as follows: Any one of them is able to fulfill the task of offering up to sixty-four concurrent channels without intra-system interference.

| i | B1 | B2 | B3 | B4 | B5 | B6 |
|---|---|---|---|---|---|---|
| 1 | 11 | 19 | 20 | 21 | 22 | 27 |
| 2 | 11 | 19 | 20 | 21 | 26 | 27 |
| 3 | 11 | 19 | 20 | 22 | 25 | 27 |
| 4 | 11 | 19 | 20 | 25 | 26 | 27 |
| 5 | 11 | 19 | 21 | 22 | 24 | 27 |
| 6 | 11 | 19 | 21 | 24 | 26 | 27 |
| 7 | 11 | 19 | 22 | 24 | 25 | 27 |
| 8 | 11 | 19 | 24 | 25 | 26 | 27 |
| 9 | 11 | 20 | 21 | 22 | 23 | 27 |
| 10 | 11 | 20 | 21 | 23 | 26 | 27 |
| 11 | 11 | 20 | 22 | 23 | 25 | 27 |
| 12 | 11 | 20 | 23 | 25 | 26 | 27 |
| 13 | 11 | 21 | 22 | 23 | 24 | 27 |
| 14 | 11 | 21 | 23 | 24 | 26 | 27 |
| 15 | 11 | 22 | 23 | 24 | 25 | 27 |
| 16 | 11 | 23 | 24 | 25 | 26 | 27 |

The vectors are indexed by the PSB vector.

Acronyms and Abbreviations

| | |
|---|---|
| AFHP | Active Frequency Hopping Parameters |
| AP | Access Point |
| Ap_{ci} | Address Pattern matrix for Class c Category i |
| CAP | Channel Adaptation Process |
| CDMA | Code Divided Multiple Access |
| DSSS | Direct Sequence Spread Spectrum |
| CFHP | Candidate FHP |
| FHAA | Frequency Hopping Adaptation Algorithm |
| FHP | Frequency Hopping Parameters |
| FHSS | Frequency Hopping Spread Spectrum |
| HHR | Hopping Hitting Rate |
| ISM | Industry, Scientific and Medical Band |
| PSB | Pattern Selection Bit vector |
| TD | Transceiver Device |
| WBFH | Wide Band Frequency Hopping |
| WLAN | Wireless Local Area Network |

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A method of frequency hopping utilizing a frequency hopping adaptation algorithm comprising the steps of:
initializing a particular system;
generating a hopping sequence for said particular system;
monitoring the quality of a current logical channel; and
changing said hopping sequence if the quality of said current logical channel is not satisfactory.

2. The method of frequency hopping utilizing a frequency hopping adaptation algorithm of claim 1, further comprising the step of:
updating a candidate frequency hopping parameter and an active frequency hopping parameter if the quality of said current channel is not satisfactory.

3. The method of frequency hopping utilizing a frequency hopping adaptation algorithm of claim 2, further comprising the step of:
activating a refresh timer if said particular system has hopped to a last channel.

4. The method of frequency hopping utilizing a frequency hopping adaptation algorithm of claim 1, further comprising the step of:
refreshing said particular system if a refresh timer expires.

5. The method of frequency hopping utilizing a frequency hopping adaptation algorithm of claim 1, further comprising the step of:
testing for priority of a transceiver device.

6. The method of frequency hopping utilizing a frequency hopping adaptation algorithm of claim 5, further comprising the step of:
monitoring a surrounding environment for transceiver devices with higher priority.

7. The method of frequency hopping utilizing a frequency hopping adaptation algorithm of claim 6, further comprising the step of:
monitoring for higher priority with channel measurements.

8. The method of frequency hopping utilizing a frequency hopping adaptation algorithm of claim 1, further comprising the step of:
providing active frequency hopping parameters for a current transceiver device by deriving frequency hopping parameters from a transceiver device with the highest priority.

9. The method of frequency hopping utilizing a frequency hopping adaptation algorithm of claim 8, further comprising the step of:
changing selected bits of at least one component of an active frequency hopping parameter.

10. The method of frequency hopping utilizing a frequency hopping adaptation algorithm of claim 1, further comprising the step of:
entering a channel adaptation process if the derived active frequency hopping parameters of a current transceiver device are identical to that of a known transceiver device.

11. The method of frequency hopping utilizing a frequency hopping adaptation algorithm of claim 1, further comprising the step of:
providing an address pattern matrix with multiple vectors which are identified by a pattern selection bit vector.

12. The method of frequency hopping utilizing a frequency hopping adaptation algorithm of claim 1, further comprising the step of:
updating active frequency hopping parameters of a current transceiver device by deriving the active frequency hopping parameters from existing frequency hopping parameters.

13. The method of frequency hopping utilizing a frequency hopping adaptation algorithm of claim 1, further comprising the step of:
measuring channel quality by collecting counts on both very high and very low hop usage measurements.

14. The method of frequency hopping utilizing a frequency hopping adaptation algorithm of claim 1, further comprising the step of:
using a current channel when channel quality is not satisfactory for a set period of time, the length of the set period of time being a function of current channel quality and local information.

15. A method of frequency hopping utilizing a frequency hopping adaptation algorithm comprising the steps of:
initializing a particular system;
generating a hopping sequence for said particular system;
monitoring the quality of a current logical channel;
changing said hopping sequence if the quality of said current logical channel is not satisfactory;
updating a candidate frequency hopping parameter and an active frequency hopping parameter if the quality of said current channel is not satisfactory.

16. The method of frequency hopping utilizing a frequency hopping adaptation algorithm of claim 15, further comprising the step of:
activating a refresh timer if said particular system has hopped to a last channel.

17. The method of frequency hopping utilizing a frequency hopping adaptation algorithm of claim 15, further comprising the step of:
refreshing said particular system if a refresh timer expires.

18. The method of frequency hopping utilizing a frequency hopping adaptation algorithm of claim 15, further comprising the step of:
testing for priority of a transceiver device.

19. The method of frequency hopping utilizing a frequency hopping adaptation algorithm of claim 18, further comprising the step of:
monitoring a surrounding environment for transceiver devices with higher priority.

20. The method of frequency hopping utilizing a frequency hopping adaptation algorithm of claim 19, further comprising the step of:
monitoring for higher priority with channel measurements.

21. The method of frequency hopping utilizing a frequency hopping adaptation algorithm of claim 20, further comprising the step of:
providing active frequency hopping parameters for a current transceiver device by deriving frequency hopping parameters from a transceiver device with the highest priority.

22. The method of frequency hopping utilizing a frequency hopping adaptation algorithm of claim 21, further comprising the step of:
changing selected bits of at least one component of an active frequency hopping parameter.

23. The method of frequency hopping utilizing a frequency hopping adaptation algorithm of claim 15, further comprising the step of:
entering a channel adaptation process if the derived active frequency hopping parameters of a current transceiver device are identical to that of a known transceiver device.

24. The method of frequency hopping utilizing a frequency hopping adaptation algorithm of claim 15, further comprising the step of:
providing an address pattern matrix with multiple vectors which are identified by a pattern selection bit vector.

25. The method of frequency hopping utilizing a frequency hopping adaptation algorithm of claim 15, further comprising the step of:
updating active frequency hopping parameters of a current transceiver device by deriving the active frequency hopping parameters from existing frequency hopping parameters.

26. The method of frequency hopping utilizing a frequency hopping adaptation algorithm of claim 15, further comprising the step of:
measuring channel quality by collecting counts on both very high and very low hop usage measurements.

27. The method of frequency hopping utilizing a frequency hopping adaptation algorithm of claim 15, further comprising the step of:
using a current channel when channel quality is not satisfactory for a set period of time, the length of the set period of time being a function of current channel quality and local information.
